(19) United States
(12) Patent Application Publication
(10) Pub. No.: US 2011/0055111 A1
(43) Pub. Date: Mar. 3, 2011

(54) HEDGING AGREEMENT ROLL-OVERS

(75) Inventors: Carsten POHL, Mannheim (DE); Madhusudan P, Bangalore (IN); Stephan HEINZ, Heddesheim (DE); Sandip ROY, Dhanbad (IN); Pankaj JAIN, Delhi (IN); AR VINODH, Chennai (IN); Klaus MUELLER, Neustadt a.d. Weinstrasse (DE)

(73) Assignee: SAP AG, Walldorf (DE)

(21) Appl. No.: 12/550,565

(22) Filed: Aug. 31, 2009

(51) Int. Cl. G06Q 40/00

(52) U.S. Cl. 705/36 R

(57) ABSTRACT

Systems, methods, and articles for managing hedging agreement roll overs in forward securities transactions are provided. In an embodiment, a forward securities transaction business object records data relating to a hedging agreement as well as any subsequent roll over data. In an embodiment, the original hedging agreement data and the subsequent roll over data may be used in an embodiment to calculate the effectiveness of the hedging agreement to determine whether hedge accounting may be used to account for the hedging agreement. The data in the forward securities transaction business object may be used in some embodiments in other calculations as well, such as accounting calculations or rate of return calculations.

### BACKGROUND

Hedging is a risk management strategy that minimizes the risk of future price fluctuations, and possible future losses, by agreeing on a price and quantity of items to be exchanged at a future date. In some instances, the items to be exchanged at a future date may include securities, such as bond, stocks, mutual funds, notes, or mortgages.

In computing systems, such as enterprise resource planning systems, data relating to hedging transactions involving these securities may be stored in data objects known as forward securities transactions. The forward securities transactions may include a link to a hedged item, such as a security, and agreed terms of existing hedging relationship between parties, such as price, quantity, and date terms.

In some instances, data relating to the terms of an existing hedging relationship may be extended or changed before the end of the hedging relationship. In this situation the existing hedging relationship terms may be rolled over into a modified forward securities transaction containing the renegotiated terms.

Current enterprise resource planning systems 14 shown in FIG. 1 are not capable of processing or managing these roll overs of forward securities transactions. Furthermore, existing systems are not capable of properly accounting for rolled over forward securities transactions using accounting standards such as International Financial Reporting Standards.

For example, an initial forward securities transaction business object 15 may be entered in an existing system 14 to be effective at time 10, mature at time 11, and contain other transaction related data, such as spot price, mature price, quantity, and/or a link to the securities data or object. If the terms of the forward securities transaction are subsequently extended from time 11 to time 12, in existing system 14 either a second transaction object 16 may be entered to be effective at time 11 and mature at time 12, or the initial transaction object 15 may be deleted and replaced with a new transaction object 17 that is effective at time 10, matures at time 12, and contains other transaction related data.

However, in the situation where a second securities transaction object 16 is entered to cover the securities extension from time 10 to time 11, the new transaction object 16 is independent of the existing object 15 and the two object are not linked or otherwise associated with each other, making accounting and transaction management difficult. The situation where the existing transaction object 15 is deleted and replaced with a new transaction object 17 also makes accounting and transaction management difficult because data relating to the transition and extension of the forward securities transaction 17 at time 11 is not stored in the business object.

There is a need for enterprise resource planning systems that are able to manage and properly account for roll overs of forward securities transactions.

### BRIEF DESCRIPTION OF THE DRAWINGS

FIG. 1 illustrates the differences between existing systems and a new system embodiment of the invention.

FIG. 2 shows a formula in an embodiment for a retrospective effectiveness test (RET).

FIG. 3 shows a spreadsheet containing exemplary effectiveness test calculations.

FIG. 4 shows an embodiment of an enterprise resource planning system.

FIG. 5 shows the flow of information between systems in an embodiment.

### DETAILED DESCRIPTION

Embodiments provide systems and methods enabling roll overs of forward securities transactions by updating or superseding existing forward securities transaction data to accept extensions to maturity date terms or other changes to the terms of a hedging agreement. The updated data may then be automatically linked to existing data in some embodiments and both the updated data and the linked data may be used to perform automated effectiveness testing of the existing and new forward securities transactions. Upon passing the effectiveness tests, accounting data may be automatically extracted from the forward securities transaction according to hedge accounting principles and sent to an accounting system.

In an embodiment, data relating to a forward securities transaction may be stored in a forward securities transaction business object. In some embodiments, the forward securities transaction business object may enable a roll over of a securities transaction if the transaction object includes an attribute confirming the existence of a compound derivative or the forward securities transaction includes documentation or a link to documentation of a roll-over strategy. A compound derivative may be designated for a forward transaction with roll-over option.

In various embodiments, once the transaction object contains data enabling a roll over, additional data relating to the hedging transaction in the transaction object may be automatically changed. These changes may include changes to the hedging terms; such as price, quantity, or date; the link within the object to a hedged security; the documentation of the roll over strategy; or accounting calculations related to the transaction. In an embodiment, if a roll over is later reversed, these changes may be undone.

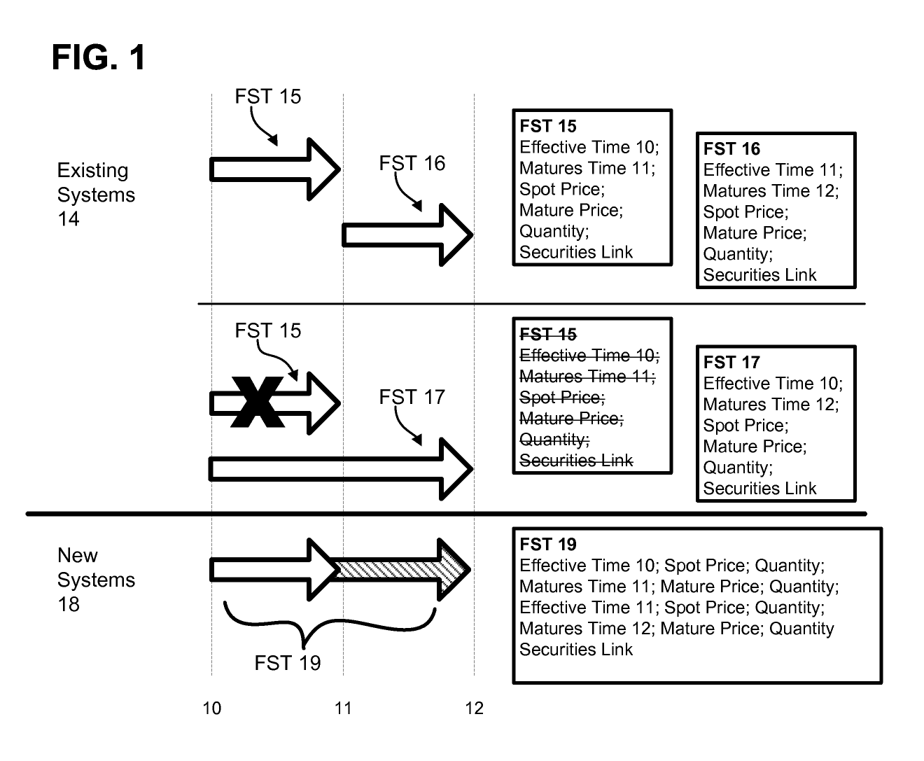

FIG. 1 illustrates the differences between existing systems 14 and a new system 18 embodiment of the invention. In an embodiment, when data representing the terms of hedging agreement are extended beyond its original maturity date, the new terms of the hedging agreement extension may be added to the transaction object 19. Thus, in an embodiment, data representing initial hedging agreement terms, such as effective time 10, spot price, initial quantity, maturity time 11, maturity price, and/or maturity quantity, may be stored in forward securities transaction object 19. If the data is later modified or extended, the new data, such as effective time 11, spot price, initial quantity, maturity time 12, maturity price, and/or maturity quantity, may be stored in forward securities transaction object 19. A link or reference to the security or securities that are part of the agreement may also be included in the object 19.

In some embodiments, data relating to a maturity date extension of a hedging agreement may be stored in a forward securities transaction business object as an additional data field. In some embodiments, maturity date data may only be extended if the documentation of the roll over strategy in the forward securities transaction permits maturity date extensions. In an embodiment, the process of adding or changing a data field in a business object may result in a new rate of return being automatically calculated for the extended forward securities transaction. In an embodiment, these and other financial calculation may be performed by a separate system, such as financial calculation system 48, which may be configured to efficiently perform such calculations. In some embodiments, when the maturity date data is extended, the calculation may be based on the rate of return before the maturity date extension. In some instances, the data representing a new rate of return may also include intermediate returns, such as dividends between roll over and maturity. In some embodiments, the return data may be compounded to the new maturity date.

In some embodiments, data fields in transaction objects may be automatically amended when a new hedging agreement in a forward securities transaction replaces or supersedes an existing hedging agreement in a forward securities transaction. In these situation, not only may the terms of the hedging agreement in the forward securities transaction be updated, but the documentation of the roll over strategy may also be updated, though a record of the existing hedging agreement may still be maintained. In some embodiments, the forward or future price may be calculated based on the spot or cash prices at the time the new hedging agreement was created.

In an embodiment, once a roll over date and new maturity have been identified, a processor may review the forward securities transaction to identify a quantity of securities that are available to be rolled over as of the date the roll over is to occur. Some or all of the identified quantity of securities may then be identified as eligible for roll over. In some embodiments, a roll over attribute may be used to prevent a user from selecting a forward securities transaction that may not be rolled over or eligible for roll over.

Hedge Effectiveness Testing

As discussed previously, hedging is typically used as part of a risk management strategy, and when used in accordance with accounting standards, may enable an entity to use hedge accounting to better reflect the reduced risk. However, before hedge accounting may be used, effectiveness tests must be conducted to verify that the hedging agreement offers adequate risk protection.

In some embodiments when data in forward securities transaction object indicates that the maturity date of a hedging agreement in a forward securities transaction has been extended, the system may ensure that the spot rate or cash price of the securities at the time of the original hedging agreement in the forward securities transaction is not changed during the roll over and extension of the maturity date. In embodiments enabling a user to extend the maturity date of some securities in the hedging agreement, the system may ensure that only the rolled over units are taken into account during effectiveness testing after the roll over date.

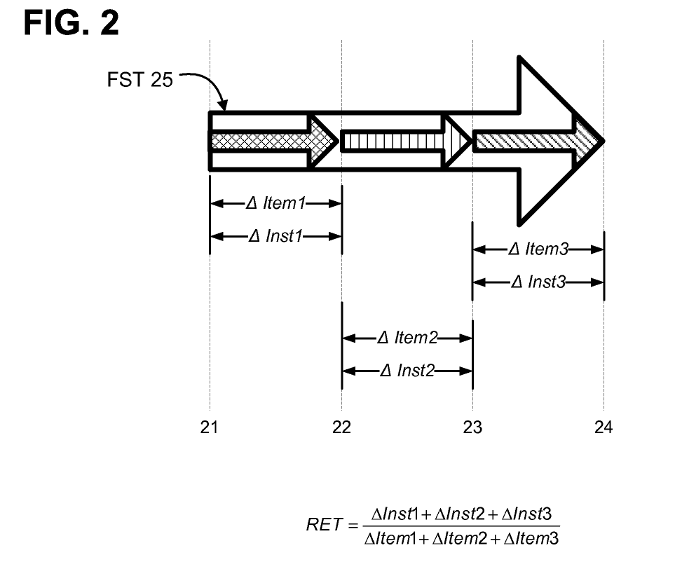

In embodiments enabling a user to assign a new hedging agreement in a forward securities transaction to replace or supersede an existing hedging agreement in a forward securities transaction, the effectiveness tests may require using multiple spot rates or cash prices of the securities at the time each new hedging agreement was entered into. This is because, as shown in FIG. 2, some effectiveness tests are based on the change in the price of the security relative to the change in price of the hedging agreement, both of which may depend on the spot price or cash price at time each hedging agreement was entered into.

FIG. 2 shows a formula in an embodiment for a retrospective effectiveness test (RET) involving the terms of a hedging agreement that has been twice extended in forward securities transaction object 25. The initial hedging terms were effective at time 21 and expired at time 22. At time 22, the hedging agreement was extended to time 23, and at time 23, the hedging agreement was extended to time 24. The RET at time 24 may be calculated in an embodiment as the change in value of the securities underlying hedging agreement between times 21 to 22, 22 to 23, and 23 to 24, divided by the change in value of the hedging agreement between times 21 to 22, 22 to 23, and 23 to 24.

These or other embodiments may use the following formula as an effective test for a series of forward securities transactions, HInstr_{m,m+1}, with forward rates, f_{m,m+1}, and spot rates, s_{m,m+1}, being designated in xthe hedging agreement in the time intervals (tₘ, tₘ₊₁). The respective underlying securities corresponding to HInstr_{m,m+1} may be designated as HUnder_{m,m+1} with security price S_{Under}, the designation time may be t_{des}=t₁, and the security price of the hedged item at time t may be S_{HItem}(t), then:
The gains/losses of the respective forward securities transactions HInstr_{m,m+1} (begin of term tₘ, end of term tₘ₊₁) at point in time tₘ₊₁ may be: f_{m,m+1}−S_{Under}(tₘ₊₁).
The intrinsic values of the forward securities transactions HInstr_{m,m+1} for tₘ≦t≦tₘ₊₁ may be: IV_{HInstr}_{_{m,m+1}}(t)=s_{m,m+1}−S_{Under}(t).
The number of designated units in the forward securities transaction HInstr_{m,m+1} at time t may be n_{Hinstr}_{_{m,m+1}}(t) for tₘ≦t≦tₘ₊₁ and for the hedged item n_{HItem}_{_{m,m+1}}(t). The numbers may be constant for tₘ≦t≦tₘ₊₁ and the numbers may be monotonically decreasing in some embodiments but not necessarily strictly monotonically decreasing.
D_{m,m+1,k}^{Instr} may be the dividends of the underlying of the Hedging Instrument in the interval tₘ≦t≦tₘ₊₁.
D_{m,m+1,k} may be the dividends of the Hedged Item in the interval tₘ≦t≦tₘ₊₁.

Accordingly, in an embodiment one cumulative retrospective effectiveness test at time t may be:

$$\begin{matrix}RET ( {t}_{des} , t ) = - \frac{Δ {HFV}_{HItem} ( {t}_{des} , t )}{Δ {HFV}_{HInstr} ( {t}_{des} , t )} = \\ = - \frac{{n}_{{HItem}_{m , m + 1}} ( t ) * ( \begin{matrix}{\sum }_{m = 1}^{C - 1} [ \begin{matrix}{S}_{HItem} ( {t}_{m + 1} ) - \\ ( \begin{matrix}{S}_{HItem} ( {t}_{m} ) - \\ {\sum }_{{t}_{m} \leq {t}_{k} \leq {t}_{m + 1}} {D}_{m , m + 1 m , k}\end{matrix} )\end{matrix} ] + \\ [ \begin{matrix}{S}_{HItem} ( t ) - \\ ( \begin{matrix}{S}_{HItem} ( {t}_{C} ) - \\ {\sum }_{{t}_{C} \leq {t}_{k} \leq t} {D}_{C , C + 1 , k}\end{matrix} )\end{matrix} ]\end{matrix} )}{{n}_{{HInstr}_{m , m + 1}} ( t ) * ( \begin{matrix}{\sum }_{m = 1}^{C - 1} [ \begin{matrix}( \begin{matrix}{IV}_{{HInstr}_{m , m + 1}} ( {t}_{m + 1} ) - \\ {\sum }_{{t}_{m} \leq {t}_{k} \leq {t}_{m + 1}} {D}_{m , m + 1 , k}^{Instr}\end{matrix} ) - \\ {IV}_{{HInstr}_{m , m + 1}} ( {t}_{m} )\end{matrix} ] + \\ [ \begin{matrix}( \begin{matrix}{IV}_{{HInstr}_{C , C + 1}} ( t ) - \\ {\sum }_{{t}_{C} \leq {t}_{k} \leq t} {D}_{C , C + 1 , k}^{Instr}\end{matrix} ) - \\ {IV}_{{HInstr}_{C , C + 1}} ( {t}_{C} )\end{matrix} ]\end{matrix} )}\end{matrix}$$

$$for {t}_{C} \leq t \leq {t}_{C + 1} .$$

This formula may also be used as an effectiveness test in other embodiments, such as in the case of extending the maturity date of a hedging agreement in a roll over forward securities transaction. Other formulas that calculate the change in the fair value of the hedging agreement(s) may also be used in different embodiments. These formulas may include the difference of the intrinsic values of previously matured portions of hedging agreement(s) at the time the agreement become effective and the date the agreement(s) matured added to the current change intrinsic value from the original intrinsic value of the non-matured portion of the hedging agreement(s).

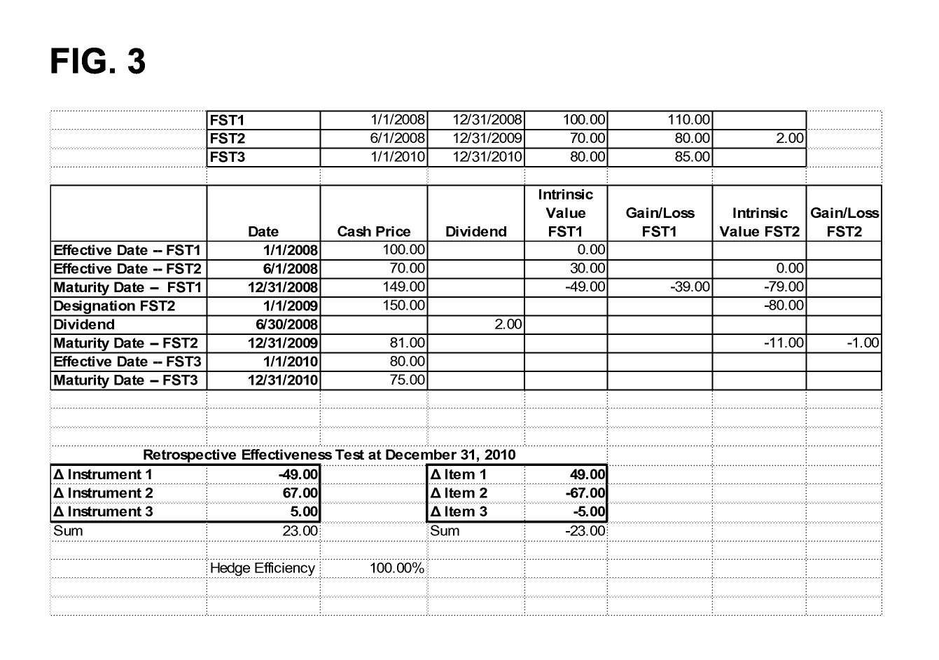

FIG. 3 shows a spreadsheet containing exemplary effectiveness test calculations performed in an embodiment using the above mentioned effectiveness test formulas. For example, for the first transaction FST1 beginning on Jan. 1, 2008 and ending Dec. 31, 2008, the cash price of the security increased from $100 on Jan. 1, 2008 to $149 on Dec. 31, 2008. This price increase reduced the value of the hedging agreement by $49, resulting in a Δ Instrument of minus 49 (−49), but increase the value of the security item by $49, resulting in a Δ Item of plus 49 (+49).

For the second transaction FST2, the cash price at the start of term on Jun. 1, 2008 was $70, but the second hedging transaction FST2 did not take effect until Jan. 1, 2009, one day after the end of the first hedging transaction FST1. If the cash price on Jan. 1, 2009 was $150, this price increase from $70 reduced the value of the hedging agreement by $80. If a $2 dividend is paid on Jun. 1, 2008, the value of the hedging agreement was further reduced to $78. If the cash price at maturity was $81 compared to the cash price of $70 at the start of the term, the value of the hedging agreement at maturity has reduced by $11 compared to the value at the start of the term. Thus, the instrument has gained $67 in value since transaction FST2 took effect on Jan. 1, 2009: −$11−(−$78)=+$67.

If the cash price of FST2 was $81 at maturity, $150 at the time the transaction FST2 was designated on Jan. 1, 2009, and a $2 dividend was paid at the start of the term of FST2, then the change in value of the security is: $81−$2−$150=−$67. For the third transaction FST3, if the cash price at the effective date of Jan. 1, 2010 is $80, and the cash price at maturity is $75, the hedging agreement will have gained $5 in value, $80−$75=+$5. On the other hand, the value of the security itself will have lost $5 in value. Using the results from these calculations, the total change in instrument value is +$23, where as the total change in item value is −$23. Dividing these two number gives a value of 1 or 100%. Thus, the example in FIG. 3 has a hedge efficiency of 100%.

Other formulas may be used in other embodiments to calculate hedge effectiveness. For example, in a second formula, following definitions may be used to calculate hedge efficiency:
S(t) Spot price of security, time t
Fₙ(t) Forward price of security, time tₙ in t
f_{m,n}(t) Price of forward transaction, term tₘ to tₙ
K_{m,n} Forward rate (contracted rate) of forward transaction, term tₘ to tₙ
lₙ Dividend paid at tₙ
rₖ Interest rate for period t to tₖ
r_{m,n} Interest rate for period tₘ to tₙ
   Based on this, the forward rate of the security may be as follows:

$${F}_{n} ( t ) = [ S ( t ) - {\sum }_{t < {t}_{k} < {t}_{n}} {l}_{k} * {e}^{- {r}_{k} * ( {t}_{k} - t )} ] * {e}^{{r}_{n} * ( {t}_{n} - t )} \qquad ( 1 )$$

If, in an embodiment, a forward securities transaction is created to have a net present value of zero at an effective date, the price at maturity may be:

$$\begin{matrix}{K}_{m , n} = {F}_{n} ( {t}_{m} ) \\ = ( S ( {t}_{m} ) - {\sum }_{t < {t}_{k} < {t}_{n}} {l}_{k} * {e}^{- {r}_{k} * ( {t}_{k} - t )} ) * {e}^{{r}_{m , n} * ( {t}_{n} - {t}_{m} )}\end{matrix} \qquad ( 2 )$$

The price of the forward securities transaction at time t between tₘ and tₙ may be determined by:

$${f}_{m , n} ( t ) = S ( t ) - {\sum }_{t < {t}_{k} < {t}_{n}} {l}_{k} * {e}^{- {r}_{k} * ( {t}_{k} - t )} - {K}_{m , n} * {e}^{- {r}_{n} * ( {t}_{n} - t )} \qquad ( 3 )$$

Hedge efficiency may be measured in some embodiments as the change in spot rate or cash price in relation to the change in forward rate. Changes in the spot rate, resulting solely from a dividend payout, may be eliminated in some embodiments for the change in forward rate to remain consistent with the above definition of a forward transaction price f_{m,n} in the above formula (3).

In these embodiments, hedge efficiency may then calculated as follows:

$$HE ( {t}_{A} , {t}_{B} ) = \frac{S ( {t}_{B} ) - S ( {t}_{A} ) + {\sum }_{{t}_{A} < {t}_{k} < {t}_{B}} {l}_{k} * {e}^{- {r}_{k} * ( {t}_{k} - {t}_{B} )}}{{f}_{m , n} ( {t}_{B} ) - {f}_{m , n} ( {t}_{A} )} \qquad ( 4 )$$

If interest rate effects are eliminated, the denominator in (4) can be converted to:

$${f}_{m , n} ( {t}_{B} ) - {f}_{m , n} ( {t}_{A} ) \approx S ( {t}_{B} ) - S ( {t}_{A} ) + {\sum }_{{t}_{A} < {t}_{k} < {t}_{B}} {l}_{k} \qquad ( 5 )$$

and the hedge effectiveness, after neglecting interest rate changes, is exactly 100%.

In some embodiments, an exact value of the forward securities transaction at maturity may be calculated using the following formula:

f_{m,m+1}(tₘ₊₁)=S(tₘ₊₁)−K_{n,m+1} (6)

Although the parties may opt to settle exact value at maturity with a cash payment in some circumstances, for purposes of hedge accounting, the exact value should be transferred to a follow-up agreement to retain the reserves relating to the corresponding forward securities transaction. In some embodiments, this may mean that the forward rate to be agreed on in the new roll over transaction needs to be adjusted by a cash settlement amount, including interest, from the previous transaction. When this transaction is concluded, the new forward may not have the value zero, but rather the value of the cash settlement of the previous transaction:

f_{m+1,m+2}(tₘ₊₁)=f_{m,m+1}(tₘ₊₁) (7)

The new forward may have this value when the maturity price of the follow-up transaction is:

$${K}_{m + 1 , m + 2} = ( \begin{matrix}S ( {t}_{m + 1} ) - {\sum }_{{t}_{m + 1} < {t}_{k} < {t}_{m + 2}} {l}_{k} * {e}^{- {r}_{k} * ( {t}_{k} - {t}_{m + 1} )} - \\ [ S ( {t}_{m + 1} ) - {K}_{m , m + 1} ]\end{matrix} ) * {e}^{{r}_{m + 1 , m + 2} * ( {t}_{m + 2} - {t}_{m + 1} )} \qquad ( 8 )$$

Note that this result differs from the standard definition (2) by the cash settlement amount, including interest, of the previous transaction. If the contracted rate K_{m+1, m+2} is then applied to formula (3), the price of the second formula may be determined, thereby automatically fulfilling the conditions for formula (7).

The hedge efficiency of this rolling hedge for the period t_{A} to t_{B}, in which t_{A} is a time during the term of the first forward and t_{B} is a time during the term of the follow-on transaction may now be calculated as follows (assuming the price term remains constant when transferred to the follow-on transaction):

$$HE ( {t}_{A} , {t}_{B} ) = \frac{S ( {t}_{B} ) - S ( {t}_{A} ) + {\sum }_{{t}_{A} < {t}_{k} < {t}_{B}} {l}_{k} * {e}^{- {r}_{k} * ( {t}_{k} - {t}_{B} )}}{\begin{matrix}[ {f}_{m + 1 , m + 2} ( {t}_{B} ) - {f}_{m + 1 , m + 2} ( {t}_{m + 1} ) ] - \\ [ {f}_{m , m + 1} ( {t}_{A} ) - {f}_{m , m + 1} ( {t}_{{t}_{m + 1}} ) ]\end{matrix}} \qquad ( 9 )$$

By using (7), we rearrange the denominator:

$$[ \begin{matrix}{f}_{m + 1 , m + 2} ( {t}_{B} ) - \\ {f}_{m + 1 , m + 2} ( {t}_{m + 1} )\end{matrix} ] - [ \begin{matrix}{f}_{m , m + 1} ( {t}_{A} ) - \\ {f}_{m , m + 1} ( {t}_{{t}_{m + 1}} )\end{matrix} ] == {f}_{m + 1 , m + 2} ( {t}_{B} ) - {f}_{m + 1 , m + 2} ( {t}_{A} ) == S ( {t}_{B} ) - {\sum }_{{t}_{k} > {t}_{B}} {l}_{k} * {e}^{- {r}_{k , B} * ( {t}_{k} - {t}_{B} )} - ( \begin{matrix}S ( {t}_{m + 1} ) - \\ {\sum }_{{t}_{m + 1} < {t}_{k} < {t}_{m + 2}} {l}_{k} * {e}^{- {r}_{k} * ( {t}_{k} - {t}_{m + 1} )} - \\ ( S ( {t}_{m + 1} ) - {K}_{m , m + 1} )\end{matrix} ) * {e}^{{r}_{m + 1 , m + 2} * ( {t}_{m + 2} - {t}_{m + 1} )} * {e}^{- {r}_{B , m + 2} * ( {t}_{m + 2} - {t}_{B} )} - ( \begin{matrix}S ( {t}_{A} ) - \\ {\sum }_{{t}_{A} < {t}_{k} < {t}_{m + 1}} {l}_{k} * {e}^{- {r}_{k , A} * ( {t}_{k} - {t}_{A} )} - \\ {K}_{m , m + 1} * {e}^{- {r}_{A , m + 1} * ( {t}_{m + 1} - {t}_{A} )}\end{matrix} ) \qquad ( 10 )$$

Formula (10) can be simplified considerably by excluding all the interest effects:

$${f}_{m + 1 , m + 2} ( {t}_{B} ) - {f}_{m + 1 , m + 2} ( {t}_{m + 1} ) - ( \begin{matrix}{f}_{m , m + 1} ( {t}_{A} ) - \\ {f}_{m , m + 1} ( {t}_{{t}_{m + 1}} )\end{matrix} ) == {f}_{m + 1 , m + 2} ( {t}_{B} ) - {f}_{m , m + 1} ( {t}_{A} ) == S ( {t}_{B} ) - {\sum }_{{t}_{k} > {t}_{B}} {l}_{k} - ( \begin{matrix}S ( {t}_{m + 1} ) - {\sum }_{{t}_{m + 1} < {t}_{k} < {t}_{m + 2}} {l}_{k} - \\ [ S ( {t}_{m + 1} ) - {K}_{m , m + 1} ]\end{matrix} ) - ( S ( {t}_{A} ) - {\sum }_{{t}_{A} < {t}_{k} < {t}_{m + 1}} {l}_{k} - {K}_{m , m + 1} ) = S ( {t}_{B} ) - S ( {t}_{A} ) + {\sum }_{{t}_{A} < {t}_{k} < {t}_{B}} {l}_{k} \qquad ( 11 )$$

This result corresponds exactly to the result for a single forward (from tₘ to tₘ₊₂). In this case, hedge efficiency for the rolling hedge may also be 100%, excluding the effects of interest changes. In effect, this result confirms that from an economics point of view, the two matching forwards may have the same effect as a single forward with a longer term. The calculation shown above can be applied to additional follow-on transactions in other embodiments because of this principle. In this way, a number of rolled forwards can always be cleared in the simplest case using a single rollover.

In some embodiments, upon passing the effectiveness tests, some of the above calculated accounting data may be sent to an accounting system to be processed according to hedge accounting principles under the appropriate accounting standard, such as International Financial Reporting Standards. In some embodiments, a calculation system, such as financial calculation system 48 may retrieve relevant financial hedging data from forward securities transaction business objects stored in securities management system 41, perform financial calculations, such as effectiveness tests, and forward the results of the tests and/or relevant financial data to an accounting system 46, which may incorporate the data in appropriate financial statements using appropriate accounting standards.

In some embodiments, when a forward securities transaction is rolled over or substituted by another hedging agreement, a change in the end date or maturity date of the forward securities transaction may result in further changes to other objects. For example, in some embodiments, various tests may be performed on a period basis, such as monthly or quarterly, to measure ongoing hedging effectiveness. In some instances, the tests may depend on the maturity dates of forward securities transactions, so a change to the forward securities transaction maturity date may result in a corresponding change in testing as well, with additional being adding to a testing plan when the maturity date is increased, for example. In some embodiments, the financial calculation system 48 may be configured to automatically retrieve necessary data for these calculations from the forward securities transaction business object. Moreover, in some instances, such as when rollover is cancelled, embodiments may undo changes to these and other objects.

In some embodiments, new or modified roll overs may not be permitted in certain circumstances, such as after a hedging agreement has matured, is planned to mature, or has been revoked. In these situations, the user may be prevented from initiating a roll over until certain other conditions have occurred, such as canceling the planned maturity date.

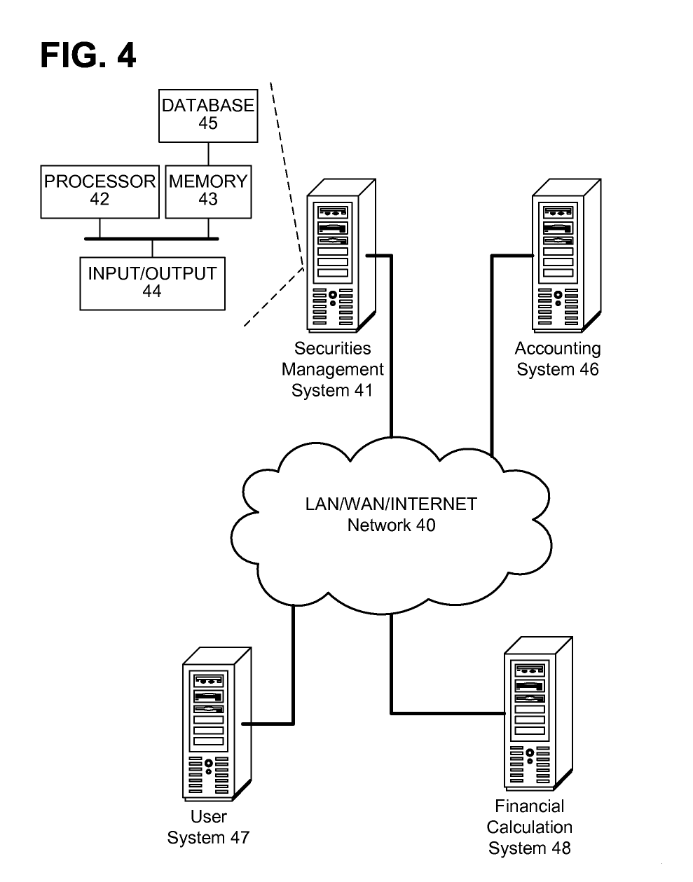

FIG. 4 shows an embodiment of an enterprise resource planning system. In this embodiment, the securities management system 41, accounting system 46, user system 47, and financial calculation system 48 make up the overall enterprise resource planning system, and are all interconnected through network 40. Each of the systems in FIG. 4 may contain a processor 42, memory 43 containing a database 45, and an input/output interface 44, all of which are interconnected via a system bus. In various embodiments, these system may have an architecture with modular hardware and/or software systems that include additional and/or different systems that communicate through one or more networks. The modular design allows a business to add, exchange, and upgrade systems, including, in some embodiments using systems from different vendors. Because of the highly customized nature of enterprise resource planning systems, different embodiments may have different types, quantities, and configurations of systems depending on the environment and organizational demands.

In an embodiment, securities management system 41 may be used to store forward securities transaction business objects. In some embodiments, securities management system 41 may also perform financial calculations involving data stored in these business objects. In other embodiments, a financial calculations system 48 may be used to perform some or all of these financial calculations, such as effectiveness tests. After completing these financial calculations, relevant accounting data, which may include the results of the calculations or data based on the results of the calculations, may be sent to an accounting system 46, which may generate corresponding financial statement data or entries. In an embodiment, changes to some data in the forward securities transaction business object, such as changes to a roll over date or maturity date, may be manually entered by a user through a user system 47. These changes may then be stored in the transaction objects, which may be stored in the securities management system 41.

In an embodiment, memory 43 may contain different components for retrieving, presenting, changing, and saving data. Memory 43 may include a variety of memory devices, for example, Dynamic Random Access Memory (DRAM), Static RAM (SRAM), flash memory, cache memory, and other memory devices. Additionally, for example, memory 43 and processor(s) 42 may be distributed across several different computers that collectively comprise a system. The memory 43 and/or database 45 may be used in the securities management system 41 to store one or more forward securities transaction business objects.

Processor 42 may perform computation and control functions of a system and comprises a suitable central processing unit (CPU). Processor 42 may comprise a single integrated circuit, such as a microprocessor, or may comprise any suitable number of integrated circuit devices and/or circuit boards working in cooperation to accomplish the functions of a processor. Processor 42 may execute computer programs, such as object-oriented computer programs, within memory 43. In some embodiments, the processor 42 in the securities management system 41 may be used to perform effectiveness tests, and other financial calculations on data stored in the securities management system 41. In other embodiments, one or more processors 42 in financial calculation system 48, which may specially configured to enable high speed financial calculations, may be used to perform the financial calculations, such as effectiveness tests on the forward securities transactions.

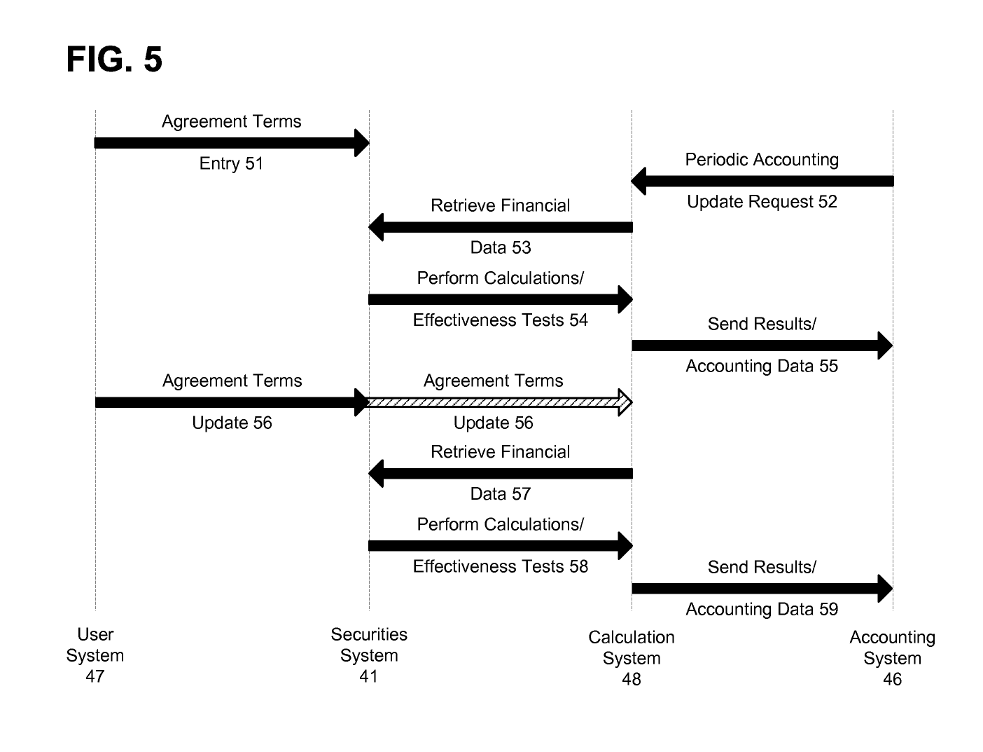

FIG. 5 shows the flow of information between the user system 47, securities system 41, calculation system 48, and accounting system 46 in an embodiment. In this embodiment, after hedging agreement terms have been entered at a user system 47, the agreement terms 51 may be sent to the securities system 41 to be stored in a forward securities transaction business object.

Sometime later, preparations to begin creating periodic financial reports or statements may commence. In an embodiment, an accounting system 46 may sent a request for an accounting update 52 when it is time to begin creating update financial reports or statements. In other embodiments, the calculation system 48 and/or the accounting system 46 may keep track of and initiated accounting update procedures at predetermined intervals, such at the close of every quarter.

The calculation system 48 may then retrieve financial data 53 relevant to the accounting update 52 from forward securities transaction objects in the securities system 41. The calculation system 48 may then perform calculations 54, such as effectiveness tests, on the retrieved financial data 53, and then send the results of the calculations 55 and/or other financial data 55 based on the results of the calculations to the accounting system 46.

Some time later, new or updated agreement terms 56 may be entered at a user system 47 and sent to the securities system 41 to be stored in a forward securities transaction business object. In some embodiments, the securities system 41 may send an automatic notification to the calculation system 48 whenever forward securities transaction business objects have been updated or changed. In other embodiments, the calculation system 48 may periodically check the securities system 41 to identify any changes to forward securities transaction business objects.

In an embodiment, upon ascertaining that a forward securities transaction business object has been changed, the calculation system 48 may then retrieve financial data 57 relevant to the updated object from the securities system 41. The calculation system 48 may then perform calculations 58, such as effectiveness tests, on the retrieved financial data 57, and then send the results of the calculations 59 and/or other financial data 59 based on the results of the calculations to the accounting system 46.

Note that while embodiments of the present invention are described in the context of a fully functional computer system, those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication links, including wireless communication links.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A securities management system comprising a processor and a memory, the processor operative to:
responsive to receiving a request to roll over a securities transaction, retrieve a forward securities transaction business object from the memory, the forward securities transaction business object including a link to a security in the securities transaction and data representing an original hedging agreement price and duration;
modify the forward securities transaction business object to include a roll over price and a duration of the rolled over hedging agreement;
perform effectiveness tests on the original hedging agreement price and duration and the roll over price and duration of the rolled over hedging agreement;
if the calculated effectiveness satisfies a predetermined accounting standard, set data in the forward securities transaction business object to a first value; and
otherwise, set data in the forward securities transaction business object to a second value.

2. The securities management system of claim 1, the processor further operative to obtain a cash price of the security during at least one of: the original hedging agreement duration and the duration of the rolled over hedging agreement.

3. The securities management system of claim 1, where data pertaining to the original hedging agreement in the forward securities transaction business object is not changed when the forward securities transaction business object is modified.

4. The securities management system of claim 1, where the forward securities transaction business object is modified only if data in the forward securities transaction business object permits roll overs.

5. The securities management system of claim 1, the processor further operative to automatically calculate a rate of return for the securities transaction when agreement data in the forward securities transaction business object is modified.

6. The securities management system of claim 5, where the rate of return calculation includes a dividend issued within at least one duration of the agreement.

7. The securities management system of claim 5, where calculations are performed by a financial calculation system.

8. The securities management system of claim 1, where data from the forward securities transaction business object is sent to an accounting system to be processed using hedge accounting when the data in the forward securities transaction business object is set to the first value.

9. The securities management system of claim 1, where a forward price is calculated based on a cash price when the hedging agreement is created.

10. The securities management system of claim 1, where a forward price is calculated based on a cash price when the roll over is created.

11. The securities management system of claim 1, where a cash price of the security is obtained at the time each roll over agreement is entered into and the obtained cash price is used in subsequent effectiveness tests.

12. The securities management system of claim 1, where further non-hedge accounting calculations are performed on data in the forward securities transaction business object when the data in the forward securities transaction business object is set to the second value.

13. The securities management system of claim 1, where the predetermined accounting standard is the International Financial Reporting Standards.

14. An article of manufacture comprising a medium storing computer readable instructions that, when executed by a processor, cause the processor to:
responsive to receiving a request to roll over a securities transaction, retrieve a forward securities transaction business object from the memory, the forward securities transaction business object including a link to a security in the securities transaction and data representing an original hedging agreement price and duration;
modify the forward securities transaction business object to include a roll over price and a duration of the rolled over hedging agreement;
perform effectiveness tests on the original hedging agreement price and duration and the roll over price and duration of the rolled over hedging agreement;
if the calculated effectiveness satisfies a predetermined accounting standard, set data in the forward securities transaction business object to a first value; and
otherwise, set data in the forward securities transaction business object to a second value.

15. A computer-implemented method comprising:
responsive to receiving a request to roll over a securities transaction, retrieving a forward securities transaction business object from the memory, the forward securities transaction business object including a link to a security in the securities transaction and data representing an original hedging agreement price and duration;
modifying, using a processor, the forward securities transaction business object to include a roll over price and a duration of the rolled over hedging agreement;
calculating, using the processor, the effectiveness of the hedging agreement by performing effectiveness tests on the original hedging agreement price and duration and the roll over price and duration of the rolled over hedging agreement;
if the calculated effectiveness satisfies a predetermined accounting standard, set data in the forward securities transaction business object using the processor to a first value; and
otherwise, set data in the forward securities transaction business object using the processor to a second value.
